(19) United States
(12) Patent Application Publication
(10) Pub. No.: US 2016/0165405 A1
(43) Pub. Date: Jun. 9, 2016

(54) DEVICES AND METHODS FOR INDOOR GEOLOCATION

(71) Applicants: Kenneth F. SHINOZUKA, New York, NY (US); Masato MIZUTA, Minamishimabara-shi (JP)

(72) Inventors: Kenneth F. SHINOZUKA, New York, NY (US); Masato MIZUTA, Minamishimabara-shi (JP)

(21) Appl. No.: 14/703,792

(22) Filed: May 4, 2015

Related U.S. Application Data
(63) Continuation-in-part of application No. 14/565,169, filed on Dec. 9, 2014.

(51) Int. Cl. H04W 4/04; H04W 4/00; H04L 29/06

(52) U.S. Cl. CPC H04W 4/04; H04L 65/102; H04W 4/008

(57) ABSTRACT

Simple methods and low-cost apparatuses for remote geolocation of subjects in an indoor environment. Each subject wears or caries a device that transmits low-power radio-frequency (RF) signals. A gateway unit in each room may relay the received low-power signals to a server on the Internet via an existing available wireless network such as WiFi or a cellular network that is connected to the Internet, and the server may determine which room each subject is located and send the information to registered users inside and/or outside the subjects' indoor environment.

### CROSS REFERENCE TO RELATED APPLICATIONS

This application claims priority as a continuation-in-part application of U.S. patent application Ser. No. 14/565,169, filed on Dec. 9, 2014 and titled “DETECTION OF CHANGES FROM A SEATED OR LYING BODY POSITION BY SENSING BODY ANGLE”, the entirety of which is herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Methods and apparatuses (including devices and systems) low-cost indoor geolocation of subjects, by making use of their existing wearable sensors or smartphones/watches embedded with low-power radio-frequency (RF) transmitters and deploying gateway unit to relay the low-power RF signals to a server on the Internet via an available wireless network, such as WiFi or a cellular network, that is connect to the Internet.

### BACKGROUND

An increasing number of people globally are subjected to a high risk of fall and/or wandering and their activity and location in an indoor environment, such as a house, a nursing care facility, or any building, needs to be closely monitored. For example, the patients, those suffering from debilitating diseases, and those suffering from dementia (including Alzheimer's) as well as other mental and medical conditions are at risk of wandering. For example, for the elderly and/or infirm, accidents and injuries may occur as a result of falls. Therefore, it would be beneficial to monitor the location and activities of the target subjects inside homes and care/nursing facilities, without requiring the use of cameras due to privacy concerns.

There is also a need for tracking moving assets in an indoor environment. For example, hospitals may track mobile medical equipment, such as X-ray machines, to improve operational efficiency.

Wireless geolocation systems have recently been developed for locating a subject (or object) in an indoor environment such as a house or a building, where traditional GPS devices do not work well. A typical wireless indoor geolocation system consists of a radio frequency (RF) transmitter on the subject (or object) to be monitored and a plurality of RF receivers fixed at various locations of the indoor environment. The location of the transmitter is estimated by analyzing the received RF signals using techniques such as triangulation, science analysis, and proximity. Various algorithms have been developed to reduce the location estimation errors caused by the lack of line of sight and multipath in an indoor environment, as exemplified by the International Patent Publication No. WO2010099294 A1.

For some applications, however, room-wise accuracy in geolocation is sufficient. For example, caregivers in a care facility often need to monitor which room each patient is currently in. There is also an increasing need for caregivers and/or family members to remotely monitor the room-wise location (to predict their activities) of the elderly living alone at home.

As an example of an existing system, TOPAZ (http://www.tadlys.co.il/media/downloads/Indoor_location_Systems.pdf) is a Bluetooth® location system that consists of Bluetooth® RFID tags, access points, Bluetooth® servers and a location server. The Bluetooth® servers are connected to a wired local area network, on which the location server identifies the access point that is nearest to each RFID tag and thus identifies its room location.

Although they may be useful for locating (or in some applications) tracking a subject's indoor geolocation, such systems are not well adapted for use with the elderly or infirm. In particular, it would be helpful to provide a simple and low-cost wireless system for room-wise indoor geolocation.

Described herein is a simple method and a low-cost wireless indoor geolocation system that takes advantage of the low-power RF transmitters embedded in subjects' existing smartphones/watches/wristbands, wearable sensors, or any smart devices that contain an low-power transmitter, and deploys a USB stick-like small gateway unit in each room to relay the received low-power RF signals to a server on the Internet through an available wireless network, such as WiFi or a cellular network, that is connected to the Internet.

### SUMMARY OF THE DISCLOSURE

Described herein are simple and reliable methods and low-cost apparatuses (including device and systems) for remotely detecting room-wise geolocation of a subject in an indoor environment (e.g. inside a house or a building), by making the subject wear a low-power RF transmitter and deploying a low-cost gateway unit in each room to relay the received low-power RF signals to a server on the Internet via a wireless network, such as WiFi or a cellular network, that is available in all the rooms and connected to the Internet.

Smartphones carried by the subjects or sensors worn by the subjects for various monitoring purposes (such as the body-angle sensing unit disclosed in the cross-referenced U.S. patent application Ser. No. 14/565,169) are often embedded with low-power RF transmitters using such wireless methods as Bluetooth® Low Energy, ZigBee, or ANT. These existing transmitters can be taken advantage of to remotely monitor the subjects' geolocation in an indoor environment. Disclosed herein is a simple and low-cost system that may include a low-power RF transmitter worn by the subject and a gateway unit placed inside each room of the house or building that the subject may access. Because of its low power consumption, the transmitter can be powered by low-capacity batteries such as a coin-cell battery and thus be made wearable. However, the low power RF transmitters have limited signal transmission distance range.

The gateway unit serves as a relay for the low-power, short-range RF signal. It is comprised of a transceiver to receive the low-power RF signal from the transmitters and to relays the signal to a serve on the Internet via a wireless network, such as WiFi or a cellular network, that is available to all the rooms and is connected to the Internet. The gateway unit may be plugged into any regular power outlet through a USB charger for power supply. The RF transmitter worn on or carried by the subject transmits low-power wireless signals at a pre-determined interval (such as one every second). The gateway unit in each room receives the transmitting signal and relays it to a server on the Internet via an available wireless network such as a WiFi or a cellular network that is connected to the Internet. The server compares the strengths of the signals from all the gateway units, accordingly estimates the room where the subject is located, and sends this location information to one or more registered users at their smartphones, smart watches, tablets, PC's, or custom-made receivers. The user can be located inside or outside the house or building where the subject is.

Multiple registered users can simultaneously monitor the subject from any place inside or outside the house/building where the patient is located, using their smartphones, smart watches, tablets, PC's, or custom-made receivers.

One or multiple registered users can simultaneously monitor multiple subjects located in different indoor environments, such as different rooms in the same house/building, or in different houses/buildings. The RF transmitter for each user has its unique identification (ID) number and may be transmitted together with the RF signal.

The low-power RF transmitter may be part of an existing wireless sensor device that the subject is wearing for various monitoring purposes, such as the body position sensing unit disclosed in the cross-referenced U.S. patent application Ser. No. 14/565,169, or a sock sensor as disclosed in U.S. Pat. No. 8,736,439, both for detecting wandering. The transmitter may also be part of a smart device such as a smart watch, smart wristband, or smart accessory that the subject is wearing. Furthermore, a smartphone carried by the subject is also embedded with a low-power RF transmitter and thus can serve the purpose of geolocation in the disclosed wireless system. By taking advantage of the subject's existing “smart” device that contains an low-power RF transmitter, the cost of the disclosed wireless indoor geolocation system can be further reduced.

In some variations the server on the Internet may be configured to trigger an alert if, for example, the RF transmitter stays in a certain room for an unusually long period of time.

Thus, described herein are simple and low-cost wireless method and system for indoor room-wise geolocation that takes advantage of existing wearable wireless sensors or smartphones/watches/wristbands embedded with low-power RF transmitters and the widely available wireless networks such as WiFi or a cellular network.

An example of a method of room-wise geolocation of one or more subjects in one or multiple indoor environments, remotely by one or more registered users, may include some or all of the steps of: placing a gateway unit comprising a transceiver in each of a plurality of rooms accessible to the subjects; transmitting, from a low-power RF transmitter carried by a subject, a low-power RF signals including unique ID information associated with the subject; receiving, at the gateway units in at least some of the plurality of rooms, the low-power RF signal; relaying the low-power RF signals received by the gateway units to a server on the Internet, the received RF signals to determine the subject's room-wise locations by comparing strengths of the signals from the different gateway units; and sending the room-wise location and unique ID information to the one or more registered users.

Any of the relays (e.g., gateway units) described herein may relay or transmit the signal encoded by the low-power RF signal, which include, for example, a unique identifier (ID) code, and/or a measure of the received signal strength or signal intensity of the low-power RF signal. Thus, any of these apparatuses may include circuitry for detection of the signal strength associated with the received signal(s). The signal strength may be digitally encoded and/or combined with the content of the low-power RF signal for transmission by the gateway units. Thus, as used herein, the phrase “relaying the low-power RF signal” may include relaying the signal content and/or information about the received low-power RF signal, including the signal strength, intensity, etc.

Relaying may include relaying to the server on the Internet via a wireless network that is available in all the rooms and connected to the Internet. The wireless network may be one or more of: a WiFi, a ZigBee, a cellular network, or any wireless network that is connected to the Internet.

Placing the gateway may include connecting the gateway to a USB port connected to a power outlet.

The gateway unit apparatus may include two transceivers: a low-power RF transceiver that receives low-power RF signals from the low-power transmitters; a moderate-to-high power RF transceiver that relays the low-power signals to a server on the Internet via an available wireless network connected to the Internet; one or more antennas for receiving and transmitting the RF signals; a microcontroller; and a USB plug for supplying power to the gateway unit.

Alternatively, the gateway unit may include only one transceiver that is configured to both receive the low-power RF signals and transmit (relay) the signals to the server on the Internet.

The methods and apparatuses disclosed herein are applicable to geolocation of not only subjects but also moving objects.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 illustrates an example of a configuration of the gateway unit that contains two transceivers and two antennas.

FIG. 2 illustrates an example of an alternative configuration of the gateway unit that contains one transceiver and one antenna.

FIG. 3 is a schematic view showing the gateway unit, which is powered by an outlet in the wall through the USB charger, before being plugged in.

FIG. 4 is a schematic view showing the gateway unit, which is powered by an outlet in the wall through the USB charger, after being plugged in.

FIG. 5 is a schematic view showing the gateway unit, which is powered by an outlet in the wall through the USB charger, before being plugged in.

FIG. 6 is a schematic view showing the gateway unit, which is directly powered by a wall outlet equipped with USB charging ports, after being plugged in.

FIG. 7 illustrates one example of the system for remotely geo-locating multiple subjects inside an indoor care facility by multiple registered users inside or outside the subjects' indoor environments. Each of the subjects wears or carries a low-power RF transmitter that transmits a low-power RF signal together with a unique ID number associated with the subject. The gateway unit is stationed in each of the rooms in the facility, receiving the low-power RF signals and the ID information from all the transmitters and relaying them, via an existing WiFi network to a server on the Internet. The server determines and sends the location information of each of the subjects to the registered users at their monitoring devices, such as smartphones, tablets, or custom-made receivers/monitors.

### DETAILED DESCRIPTION

In general, described herein are simple methods and low-cost apparatuses (including devices and systems) that remotely detect the room-wise geolocation of a subject in an indoor environment. The system makes the subject wear a low-power RF transmitter or takes advantage of an RF transmitter existing in the smartphone that the subject carries or in the sensor (such as the body angle sensor disclosed in the referenced U.S. patent application Ser. No. 14/565,169) that the subject wears. An USB stick-like, small gateway unit is deployed in each of the rooms accessible to the monitored subject. The gateway units receive the RF signal transmitted by the subject's transmitter and relay the low-power signal to a server on the Internet via an available wireless network, such as the widely available WiFi or a cellular network, that is connected to the Internet. The gateway unit in the room where the subject is located is expected to receive the strongest signal intensity. Therefore, by analyzing the strengths of the signals from the gateway units, the server can estimate which room the subject is located and sends that information to one or multiple registered users at their smartphones, smart watches, tablets, nurse station monitors or custom-made monitors.

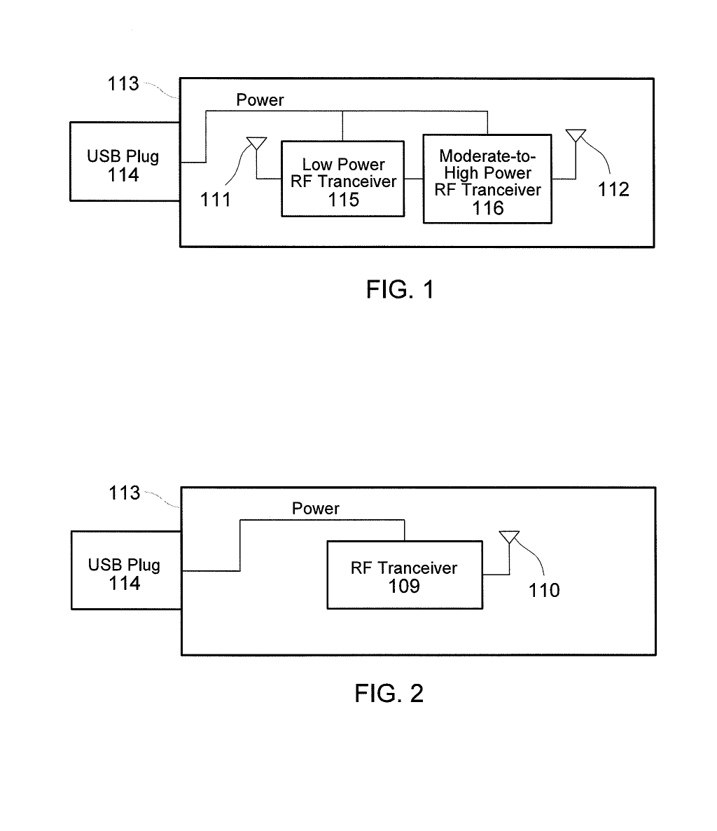

FIG. 1 shows an example of a configuration of the gateway unit 113. Housed in a case, the gateway circuit includes a low-power RF receiver 115 such as Bluetooth Low Energy, ZigBee, or ANT and a moderate-to-high-power transceiver 116 such as WiFi or a cellular network. Each transceiver has its own antenna, 111 or 112. The gateway unit contains a USB plug 114 for power charging.

FIG. 2 presents an example of an alternative configuration of the gateway unit 113. The circuit contain only one transceiver 109, with one antenna 110, configured to receive the RF signal from a low-power transmitter and to relays the signal to the server on the Internet via an available wireless network such as WiFi or cellular network connected to the Internet. The gateway unit contains an USB plug 114 for power charging.

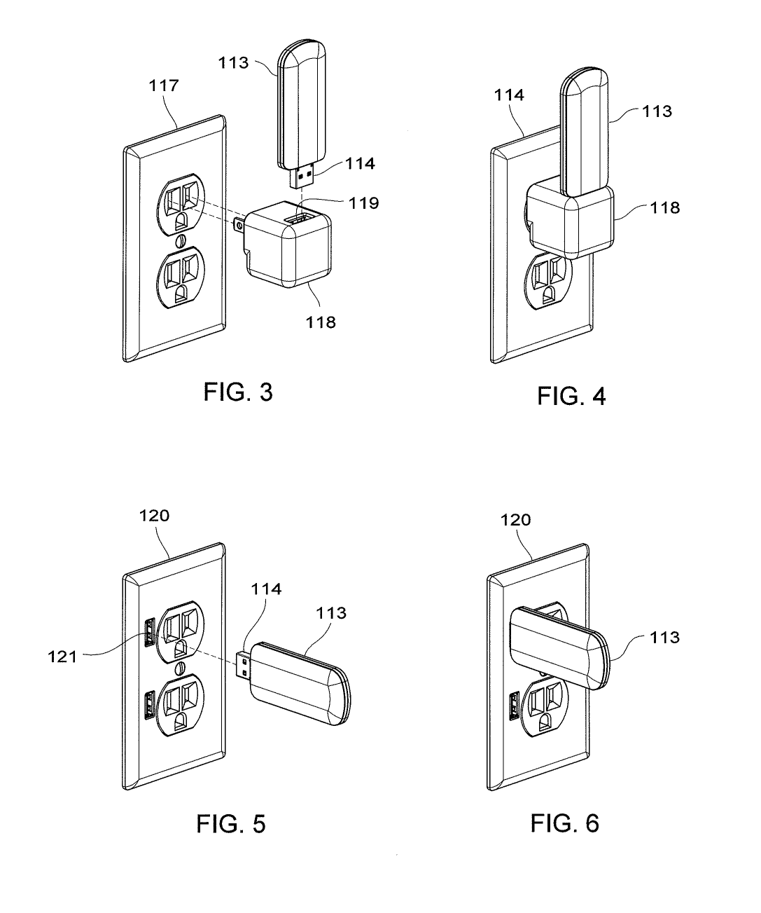

FIGS. 3 and 4 illustrate a preferred embodiment of supplying the power to the gateway circuit uses a USB charger 118 with the USB Type A plug 119, so that a standard smartphone USB charger can be used with a standard wall power outlet 117 to reduce the cost of the gateway unit.

FIGS. 5 and 6 illustrate one embodiment of the gateway unit 113 powered by a wall power outlet equipped with smartphone charging ports 121. The gateway unit 113 with USB Type A plug 114 can be directly plugged-in to the USB charging port 121 on the wall power outlet.

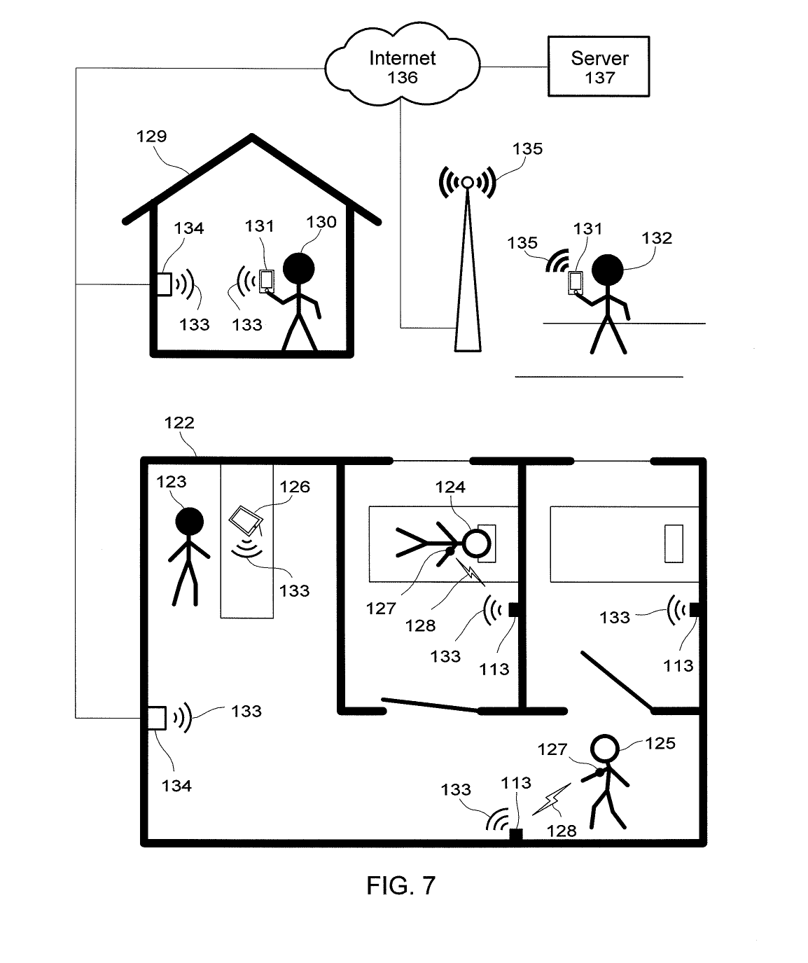

FIG. 7 schematically illustrates an example of the wireless geolocation system for remote geolocation of subjects 124 (sleeping) and 125 (walking) in an indoor care facility 122. Each of the subjects wears or caries a device 127, which transmits low-power RF signals 128 including the ID information associated with the subject, at a pre-determined time interval (such as one per second). A gateway unit 113 is plugged in a power outlet in the wall of each of the rooms, including the hallway accessible to the subjects. The gateway units 113 receive the low-power signals 128 from the subjects' devices. Taking advantage of the WiFi available in each of the rooms (including the hallway), the gateway units transform the received low-power RF signals into WiFi signals 133, which are transmitted to the server 137 on the Internet 136 through the access point 134. Analyzing the received signals, the server determines the location of each subject and sends the location information to registered users.

A registered user can be located inside the care facility such as the user 123, who might be an onsite caregiver, or outside in another indoor environment such as the user 130, who might be a relative of one of the subjects, or outdoor such as the user 132. The onsite caregiver 123 might use a tablet or a custom-made receiver (such as a nurse station monitor) to monitor the subjects' locations, while the outside users 130 and 132 might use their smartphones as a monitor. The indoor users 123 and 130 might receive the location information through WiFi 133, while the outdoor user 132 might receive the location information through a cellular network 135.

The indoor environment 122 may include, but is not limited to, a home, a care facility, a nursing home, and a hospital.

From the subjects' transmitters 127 to the gateway units 113, the RF signal 128 can be transmitted through Bluetooth® Low Energy, ZigBee, ANT, or any low-power wireless technology.

The low-power RF transmitter 127 can be a custom-made device put inside a pocket in the subject's garment or inside an accessory (such as a ring, wristband, necklace) worn by the subject or securely affixed onto the subject's garment.

The transmitter 127 can be part of a wearable sensor worn by the subject, such as the body position-sensing device disclosed in the cross-referenced U.S. patent application Ser. No. 14/565,169, or the sensor sock disclosed in the U.S. Pat. No. 8,736,439 for various monitoring purposes.

The transmitter 127 can be part of a smart watch worn by or a smartphone carried by the subject, for example, in a pocket in his or her garment.

By taking advantage of existing wearable sensors, smartphones, or smart watches that the subjects already use, the cost of the wireless indoor geolocation system can be further reduced.

Because the server on the Internet estimates the locations of the subjects based on the RF signals relayed from the subjects' transmitters by the gateway units, registered users can access the subjects' geolocation information anytime and from anywhere, indoors or outdoors, as long as their monitoring devices, such as smartphones, have WiFi or cellular signals.

Also, the subjects being simultaneously monitored by one or more registered users may be located in different indoor environments, such as different houses and/or care facilities. The RF transmitter for each user has its unique ID number and may be transmitted together with the RF signal.

There are a number of algorithms that the server can use to determine the location of the subjects 124 and 125. The simplest example is to compare the strengths of the signals received from the gateway units 113 in all the rooms inside the indoor environment 122 and select the gateway unit that has received the strongest signal intensity. Compared with objects inside the room, the walls between the rooms are likely to cause more RF signal attenuation. Therefore, the subject is most likely located in the same room where the gateway unit has received the strongest RF signal. To test the efficacy of this simple method, the subjects carrying the RF transmitter can be asked to randomly walk through all the rooms, while the server compares the strengths of the RF signals received from the gateway units in all the rooms.

The simple location algorithm, coupled with the gateway units that take advantage of the existing smartphones or wearable sensors as well as the available wireless networks, constitutes a low-cost and practical method and system for indoor room-wise geolocation.

The methods and apparatuses disclosed herein are applicable to geolocation of not only subjects but also moving objects.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of room-wise indoor geolocation of a subject remotely by one or more registered users, the method comprising:
placing a gateway unit comprising a transceiver in each of a plurality of rooms;
transmitting, from a device carried by the subject, a low-power radio frequency (RF) signal;
receiving, at the gateway units in at least some of the plurality of rooms, the low-power RF signal;
relaying the low-power RF signals received by the gateway units to a server via a wireless network that is available in all the rooms;
analyzing, at the server, the received RF signals to determine the subject's room-wise location; and
sending, from the server, the room-wise location information to the one or more registered users.

2. The method of claim 1, wherein transmitting comprises transmitting a unique identification (ID) information associated with the subject.

3. The method of claim 1, wherein the device carried by the subject is one of: a smartphone, smart watch, smart wristband, a wearable sensor unit, or any device that contains a low-power RF transmitter.

4. The method of claim 1, wherein the device carried by the subject transmits one of: a Bluetooth® Low Energy, ZigBee, ANT, or any low-power RF signal.

5. The method of claim 1, wherein the wireless network available in all the rooms is one of: a WiFi, a ZigBee, a cellular network, or any wireless network that is connected to the Internet.

6. The method of claim 1, wherein placing the gateway unit comprises connecting the gateway unit to a USB port connected to a wall power outlet.

7. The method of claim 1, wherein analyzing comprises determining the location of the subject based on a comparison of a strength of the RF signals received by the gateway units.

8. A system for room-wise geolocation of a plurality of subjects in an indoor environment, remotely by one or more registered users, the system comprising:
a device, carried by each of the subjects, that transmits a radio frequency (RF) signal including unique identification (ID) information associated with the subject;
a plurality of gateway units, configured to be placed in each of a plurality of rooms and adapted to receive the RF signal and transmit the received signal over a wireless network; and
a remote server configured to receive the RF signal relayed via the gateway unit, estimate the room-wise location of the subject based on the received RF signal, and send the room-wise location information to the one or more registered users.

9. The system of claim 8, wherein the device carried by the subject is one of: a smartphone, smart watch, smart wristband, a wearable sensor unit, or any device that contains a low-power RF transmitter.

10. The system of claim 8, wherein the device carried by the subject transmits one of: a Bluetooth® Low Energy, ZigBee, ANT, or any low-power RF signal.

11. The system of claim 8, wherein the gateway unit is configured to transmit the received signal on one of: a WiFi, a ZigBee, a cellular network, or any wireless network that is connected to the Internet.

12. A gateway unit apparatus for relaying low-power radio frequency (RF) signals to a remote server via an available wireless network connected to an Internet, the apparatus comprising:
an RF transceiver configured to receive a low-power RF signal from one or more RF transmitters and relay the low-power RF signal including an intensity measurement of the low-power RF signal, to a remote server via an available wireless network;
a microcontroller; and
a USB plug for supplying power to the gateway unit.

13. The apparatus of claim 12, wherein the RF transceiver is configured to receive the lower-power RF signal from the RF transmitter, wherein the RF transmitter comprises one or more of: a smartphone, smart watch, smart wristband, a wearable sensor unit, or any device that contains a low-power RF transmitter.

14. The apparatus of claim 12, wherein the low-power RF signal is one of: a Bluetooth® Low Energy, ZigBee, ANT, or any low-power RF signal.

15. The apparatus of claim 12, wherein the apparatus is configured to transmit on a wireless network comprising one of: a WiFi, a ZigBee, a cellular network, or any wireless network that is connected to the Internet.
